(19) United States
(12) Patent Application Publication
(10) Pub. No.: US 2004/0254974 A1
(43) Pub. Date: Dec. 16, 2004

(54) Methods and systems for assignment of user data blocks for transmission over a network

(76) Inventor: Kamel Khamfallah, Paris (FR)

Correspondence Address: FISH & RICHARDSON, PC, 12390 EL CAMINO REAL, SAN DIEGO, CA, 92130-2081, US

(21) Appl. No.: 10/460,764

(22) Filed: Jun. 11, 2003

(51) Int. Cl. G06F 15/16

(52) U.S. Cl. 709/200

(57) ABSTRACT

A user data assignment apparatus and computer implemented techniques for assigning user data blocks to resources in a network for transmission of the user data in the network. According to one embodiment, the apparatus comprises a memory region comprising a selection module and a processing unit communicatively coupled to the memory region. The processing unit is configured to execute instructions from the selection module, the instructions including: a priority loop module configured to sequentially focus user data to be operated on to user data with a particular priority; a transport format combination iteration module configured to execute within the priority loop module and to iterate through a plurality of transport format combinations; and a transfer channel module configured to execute within the transport format combination iteration module and to compute transport occupancy information corresponding to assignments of user data to particular transport format combinations.

### COPYRIGHT NOTICE

A portion of this disclosure includes pseudo-code for which copyright protection is claimed. The copyright holder has no objection to the reproduction of this material as part of production of this patent document, but otherwise reserves all copyrights to the pseudo-code set forth below.

### BACKGROUND AND SUMMARY

1. Field of the Invention.

The invention pertains to communication protocols and in particular to the assignment of user data blocks from logical channels to transport channels in a network with limited resources.

2. Background Information and Summary Wireless communication devices are deployed in wide variety of environments. More recently, as such communication devices have become widely adopted, the range of applications for which these devices are used is increasing. As the range of applications widens, so too do the types of multimedia or services that are desired to be supported by the wireless network—for example, delivery of: data, music, graphical images, and real-time video. Such services are often called “third generation” services, or “3G” services.

Existing wireless communication networks such as the Global System for Mobile communications (hereinafter “GSM”), which is deployed throughout the world, do not have the bandwidth or data rates to support the wide-scale deployment of 3G services. This is because GSM, like other second generation (“2G”) networks, was designed as a “voice-centric” wireless communication protocol.

To address this drawback and plan for future expansion of wireless services (even beyond 3G), industry leaders have proposed and adopted new wireless communication protocols that are not voice-centric. One such protocol for 3G services is the Universal Mobile Telecommunications Services (“UMTS”), which was has been developed by the Third Generation Partnership Project (“3GPP”).

In November 1999, UMTS was formally adopted by the International Telecommunications Union (“ITU”) as a member of its family of 3G standards. Consequently, UMTS deployment is already underway in Europe and Japan, which have standard 2G systems, and to a limited extent in the United States, which has no standard 2G system (in the U.S., there are three main 2G standards: TDMA and CDMA, which are found in the cellular and PCS bands, and GSM derivative PCS 1900, which is found in the PCS band only).

Compared with legacy systems, UMTS has some significant improvements. First, GSM was designed with only limited data capability; it simply does not support multiple types of multimedia. Further, while GSM supports data rates of only 9.6 kbits/second, UMTS supports a range of data rates (depending on the environment)—from 144 kbits/second in macrocellular environments to 384 kbits/second in microcellular environments, and up to 2 Mbits/second in indoor or picocellular environments.

While those of skill in the art will generally understand the structure of the UMTS standards, which is publicly available from a number of sources, including 3GPP (found on the Internet at the domain <3gpp.org>), a brief overview is appropriate. (It is noted that further details of UMTS and its origins are described by K. W. Richardson, “UMTS Overview”, Electronics and Communication Engineering Journal, June 2000, p. 93-100. Further details of W-CDMA are presented in “Designing and Testing 3GPP W-CDMA User Application”, Application Note 1356, Agilent Technologies, date not known, p. 1-15.)

UMTS supports three modes of operation, including CDMA-Direct Sequence, CDMA-Multi Carrier, and CDMA-TDD, all of which are standards generally known in the art. Wideband CDMA (hereinafter “W-CDMA”) is the leading technology for deployment of 3G networks.

W-CDMA is a code division multiple access system (“CDMA”). Contrary to time division multiple access (“TDMA”) systems, all users transmit at the same time. Further, multiple users share a common frequency carrier. In order to achieve this, each user's signal employs a unique code, which is a combination of a scrambling code and an orthogonal variable spreading factor (“OVSF”) code (also called a “channelization code”), that causes the user's signal to appear as noise to the signals of other users. The term “channel” refers to a combination of the carrier frequency and the unique code.

A W-CDMA radio link supports multiple simultaneous data channels within a single frequency carrier. Each data channel is designed to carry different media types, such as those mentioned above.

The network protocol stack of W-CDMA is depicted in FIG. 1. From the top down, layer 3 is the network layer, which comprises radio resource control (“RRC”). The RRC is based on GSM standards and is responsible for connecting services from the network to user application (e.g. a wireless telephone).

Layer 2 is the data link layer. It is comprised of the radio link control (“RLC”) sub-layer, which handles the transfer of user data, error correction, flow control, protocol error detection and recovery, and ciphering, and the medium access control (“MAC”) sub-layer, which is responsible for mapping between logical channels and transport channels, including the multiplexing and de-multiplexing of various logical channels onto the same transport channel.

Layer 1, the physical layer, maps the transport channels onto the physical channels and performs all of the RF functions needed to make the wireless protocol function properly, including frequency and time synchronization, rate matching, signal spreading and modulation, power control, and handoff functions.

Logical channels are configured to support the information content that will ultimately be transmitted over the physical channels. Transport channels are used to support the sharing of physical resources between multiple services. Each service (e.g., data, fax, voice, or signaling) can have different data rates and overhead (e.g. error control) associated with it.

FIG. 2 shows an exemplary data structure for a W-CDMA protocol. FIG. 2 is simply an abstraction to illustrate the structure of a frame 20, which, in terms of a tangible structure, is basically a data structure for carrying transport blocks 26, the transport blocks 26 holding user data (data blocks 30 and 32).

Returning to a more formal description of the carrier or “transport structure” 16: a frame 20 is comprised of a series of slots 22 (there can be 15 slots 22), and has a duration of 10 milliseconds. Each slot 22 is comprised of a series of transport channels 24 (there can be 32 transport channels). Each transport channel 24 is comprised of a series of transport blocks 26. The transport blocks 26 can have different fundamental unit sizes and different transport channels 24 can have varying numbers of transport blocks 26.

As is mentioned above, 3G networks support various data types, so it will now be described how the data that is desired to be sent relates back to the transport and in particular the user data structure 18. W-CDMA has a number of logical channels 28 (there can be up to 64 logical channels 28). Each logical channel 28 is configured to hold one or more types of data (multimedia). The logical channels 28 can vary in size and have different parameters, such as the elementary block size, the number of blocks in the channel, the size of the data to transmit, and the number of data blocks to transmit. Thus, the logical channels are comprised of a number of data blocks 30.

Each logical channel 28 is mapped to a transport channel 26. More than one logical channel can be mapped to a single transport channel. This is called a “mapping”. The mapping is specified by the wireless network. The mapping between logical channels 28 and transport channels 24 is depicted in FIG. 2 as the series of arrows from the logical channels 28 pointing toward the transport channels 24.

Here lies a problem: while a mapping between the logical channels 28 and transport channels 24 exists, it is not necessarily the case that the mapped transport channel 24 will be able to carry all of the data blocks 30 in the logical channel 28. To further complicate this problem, each network may specify different transport format combinations 34 (there can be up to 1024 transport format combinations) that represent valid combinations of transport blocks 26 over each of the multiple transport channels 24 in the slots 22. For instance, in a transport format combination each transport channel 24 may be allocated a different number of transport blocks 26. And the size of and number of transport channels 24 may change while the network is operating based on various load factors and desired signal characteristics.

Further, the 3GPP TS 25.431 V.4.2.0 (2001-09): MAC Protocol Specification (Release 4) specifies the following criteria of each transport format combination:

A) It must belong to the transport format combination set provided by the network.

B) It must not be in a blocked state (meaning the transmission of a particular transport format combination must not cause the user application to exceed a maximum allowed power).

C) It must be compatible with the RLC configuration.

D) It must not require the RLC to produce padding.

E) It must not carry more bits than can be transmitted in a transport channel.

The network will devise a set of transport format combinations 34 that satisfy the above criteria. However, the selection of a particular transport format combination from the set of TFCs 34 for each transport channel is left open to interpretation by the system implementers. However, the selection must satisfy the following additional criteria (set by the UMTS standard 3GPP TS. 25.321 V.4.2.0, found in section 11.4):

1) No other transport format combination to be selected shall allow the transmission of more, higher priority data than the chosen transport format combination.

2) No other transport format combination to be selected shall allow the transmission of more data from the next lower priority logical channels.

3) No other transport format combination shall have a lower bit rate than the chosen transport channel format.

Since transport channel format combinations must be selected for each frame, the selection routine must complete every transmit time interval (“TTI”) (which is 10 milliseconds). Furthermore, the transport channel format combination sets will vary typically from call to call. Further still, the user data to be transmitted will vary by application and size; it is completely unpredictable. Given the variables of the problem and the time to solve it, the inevitable solution is to compromise efficiency in selection to satisfy the timing constraints, or to employ increasingly more powerful microprocessors with faster and faster cycle times, which compromise battery power available for the user application.

What is appreciated is that the problem is analogous to the integer knapsack problem, which is: given n objets each of size Sizeᵢ, and a knapsack with size LIMIT, chose the set of objects with total size maximum without exceeding LIMIT with the possibility of splitting the objects. The following pseudo-code is illustrative:

TABLE 1

```
TotalSize = 0
for i = 1; i ≦ n
    if ( TotalSize < LIMIT)
        TotalSize [symbol] TotalSize + min(Size_{i,} LIMIT − TotalSize)
    endif
endfor
```

A user data assignment apparatus and computer implemented techniques for assigning user data blocks to resources in a network for transmission of the user data in the network.

According to one embodiment, the apparatus comprises a memory region comprising a selection module and a processing unit communicatively coupled to the memory region. The processing unit is configured to execute instructions from the selection module, the instructions including: a priority loop module configured to sequentially focus user data to be operated on to user data with a particular priority; a transport format combination iteration module configured to execute within the priority loop module and to iterate through a plurality of transport format combinations; and a transfer channel module configured to execute within the transport format combination iteration module and to compute transport occupancy information corresponding to assignments of user data to particular transport format combinations.

According to another embodiment, the computer implemented method for user data assignment for a network, comprises: receiving a plurality of user data blocks, the user data blocks having a plurality of priorities; executing an outer loop over the user data blocks based upon priority; within the outer loop, executing a transport format combination loop over every non-eliminated transport format combination; and within the transport format combination loop, executing a transfer channel routine.

According to one embodiment, a transport occupancy value is computed. The transport occupancy depends on the buffer occupancy of the user data and the available space in transport channels given a particular transport format combination. In one embodiment, the transfer channel routine performs acts comprising calculating a quantity of user data blocks to transmit; calculating a transport occupancy based in part on the quantity of user data blocks to transmit; and assigning the user data blocks to a transport format combination based in part on the transport occupancy information. According to one technique, the transfer channel routine acts without regard to transmit time interval data. However, in another technique, the transfer channel routine acts with regard to transmit time interval data. Details for these calculations are shown in TABLES 6-7.

In another embodiment, where two or more logical channels have the same priority and map to the same transport channel, a queue is formed to alternate placement of user data from the two or more logical channels into transport blocks for the transport channel. In one technique, the selection of which user data to place or assign is based on a FIFO approach, in another technique, a round-robin approach is employed.

According to one embodiment, a bit rate is computed for a plurality of transport format combinations and the transport format combination with the lowest bit rate is selected as the solution transport format combination.

Transport format combination elimination, bit rate calculation, and resource balancing techniques are also disclosed. Other details and advantages of the technology are described in detail below with reference to the figures and tables, while embodiments of the invention are set forth in the claims below.

### BRIEF DESCRIPTION OF THE DRAWINGS

FIG. 1 depicts a UMTS protocol stack.

FIG. 2 depicts UMTS protocol data structures.

FIG. 3 depicts an architectural overview of the transport format combination selection module, attendant memory data structures, and network functions.

FIG. 4 is a schematic depicting user application hardware in which the methods and techniques can operate.

FIG. 5 depicts a UMTS protocol stack showing where the methods and techniques operate from a software stack perspective.

FIG. 6 is a flowchart detailing an embodiment of the transport format combination selection algorithm.

FIG. 7 depicts a transport format combination set for transport channels with varying transmit time intervals and a logical channel to transport channel mapping.

FIG. 8 depicts a logical channel to transport channel mapping.

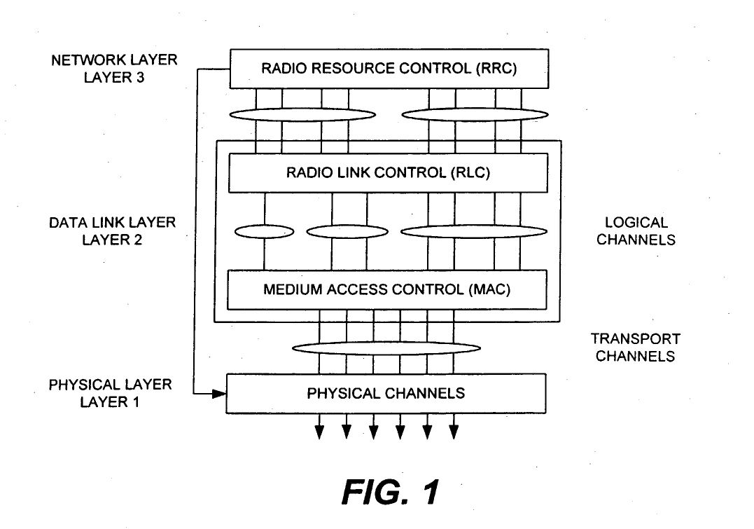

### DETAILED DESCRIPTION OF THE PREFERRED EMBODIMENTS

The problem solved concerns how to assign multiple user data blocks associated with various logical channels to transport channels for transmission in a network. According to an embodiment, the transport channels are resources in a UMTS network, and the availability of these resources, coupled with the varying amount and types of user data blocks, makes allocation of these resources a complex technical problem.

For example, a user application may wish to communicate with a network on various levels at the same time, for instance mixing speech, data and graphics image data blocks over the same underlying carrier (or frame). However, the carrier may only have a certain number of or combinations of transport channels and only a certain amount of carrier capacity available.

The problem, then, was determining which combinations of transport channels, and hence which user data block combinations would be the most optimal use of the available resources given certain network operating conditions. The solutions described below, however, while specifically addressing the problem stated above, are also of general applicability and so can be used to solve transmission problems in other environments and contexts as well, such as similar problems with terrestrial networks. Thus, unless otherwise stated in the claims, it is not intended to limit the solution to the precise environment or exact problem set forth above.

Set forth below are computer implemented methods, data structures, and apparatuses that are used to dictate which user data blocks, in a set of user data blocks, should be transmitted and using what resources, over a network with limited resources. According to embodiments, the methods, data structures, and apparatuses adapt a small amount of system resources to give optimal performance for user applications using a wireless protocol.

A transport format combination (“TFC”) selection apparatus, computer implemented methods, and data structures are described, which are useful to solve the problems set forth above. The underlying advancement to the useful arts or inventive steps are computer implemented techniques that can be embodied in a wireless protocol stack, especially in the W-CDMA protocol stack, and executed in or with an electronic device, such as a stand-alone computer, laptop computer, personal digital assistant, computer peripheral device, or an electronic communication device (such as a telephone or network connection point) that allocate user data to limited system resources for optimal transmission over a network.

### Operational Overview

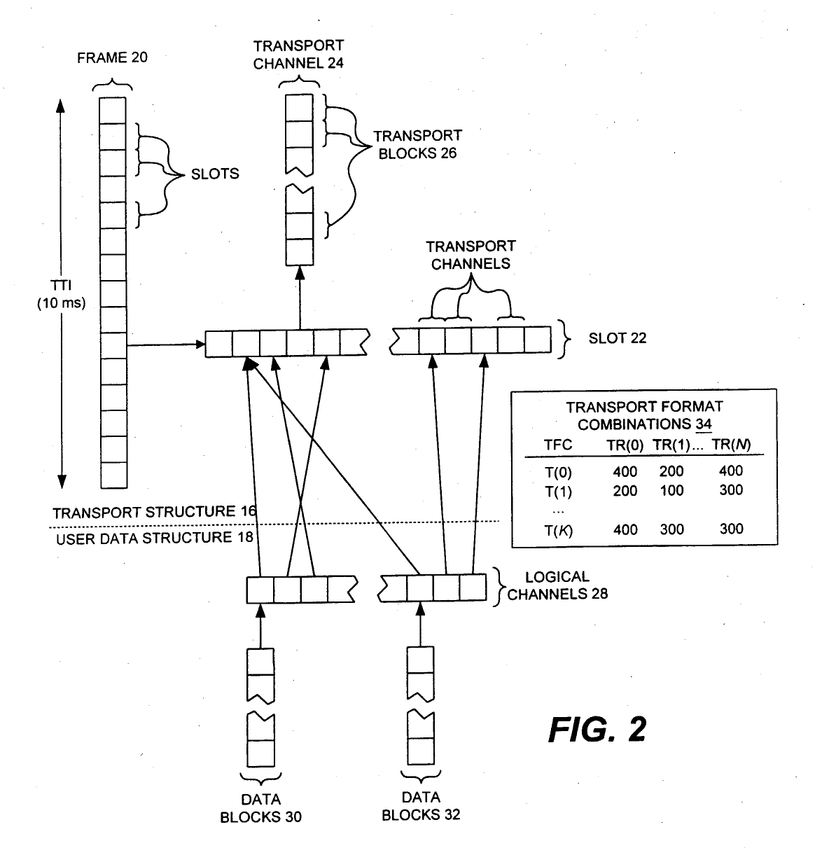

FIG. 2 depicts a transport structure 16 representative of a frame 20, which is the standard data structure on which the TFC techniques operate. Again, the frame 20 comprises multiple transport blocks 26, which are grouped into slots 22, and transport channels 24. The transport structure 16 is known in the art and it is described above, but it is mentioned here because a reference to the transport structure 16 is useful in understanding the inventive techniques set forth herein.

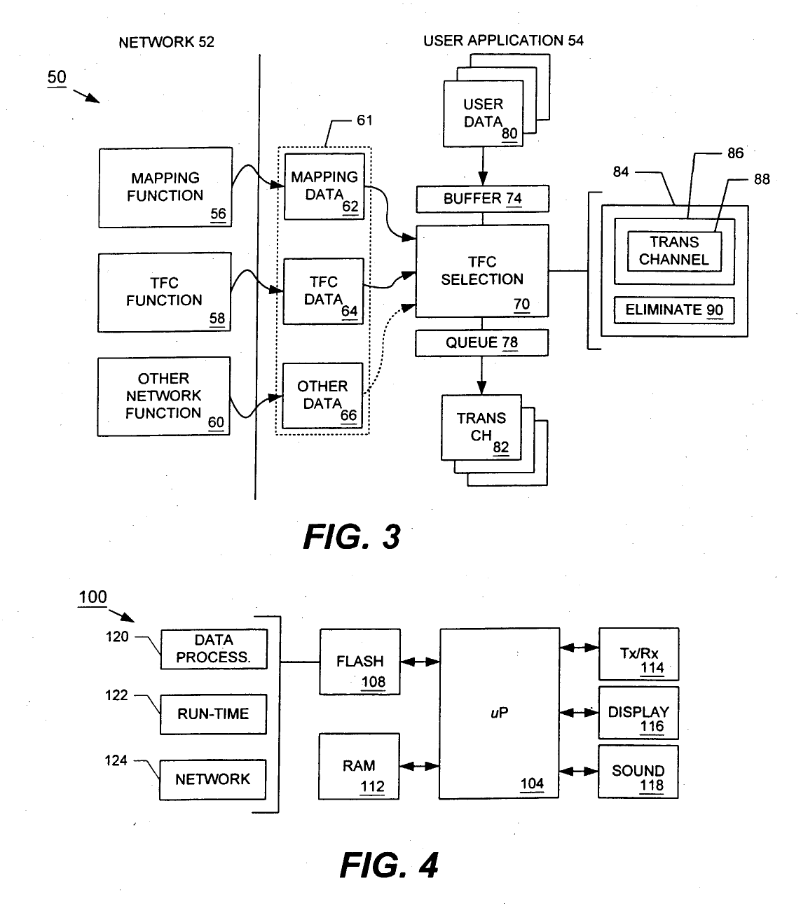

FIG. 3 is an architectural overview of a wireless network system 50 in which the inventive techniques can operate, such as a UMTS system. The diagram is more of a data flow and block diagram depicting the general operation of the transport format combination selection apparatus and methods than a hardware overview, although certain basic hardware elements would support what is depicted.

The network system 50 is bifurcated into a network provision 52 and a user application provision 54, with corresponding structures in each. These structures can be data structures, program modules, or electronic hardware, for instance.

Turning to the network provision 52, a mapping function 56 is shown that enforces general mapping constraints that must be followed by the network system 50. A transport format combination function 58 lists the transport format combinations that can be used to fill the frame 20 in the network system 50. Typically, the transport format combinations (e.g. TFCs 34) (also called “transport format combination sets” or “TFCS”) are fixed over the duration of a call, but a new set of TFCs is typically sent from the network 52 to the user application 54 when a new call is initialized. Other network functions, which are not essential to an understanding of the inventive techniques described herein, are simply shown as other network functions 60.

In the user application provision 54, there is a memory region 61 that includes areas for: mapping data 62, which is local mapping data (including the mapping functions) derived from the mapping function 56; transport format combination data 64, which is local TFC data derived from or explicitly provided by the TFC function 58; and other data 66, which is local network data used to enforce or provide general network protocol constraints and other information, such as security data.

The memory region 61 can have volatile and non-volatile memory areas, both of which are communicatively coupled to a processing unit, the general notion being that much of the data and information contained in these regions is received from the network provision 52 to the user application 54 when a link is established between the two. Other information, however, can be persistently stored in these regions, in particular the other data 66, which can provide basic call setup and linking information for the user application 54 to initialize a link with the network provision 52.

A TFC selection module 70 accesses data from the memory region 61, including the mapping data 62, the TFC data 64, and, optionally, the other data 66. This accessed data is used to provide operating parameters for the TFC selection module 70. The TFC selection module 70 typically comprises one or more sequences of instructions that are configured to cause a microprocessor to perform the TFC selection algorithm. The TFC selection algorithm selects the optimal TFC combinations, from a large number of TFC combinations, for mapping user data 80 from a plurality of logical channels 28 to a plurality of transport channels 24 in a slot 22. This, in turn, drives the placement of user data 80 (e.g. user data blocks 30) into one or more transport channels 82 (e.g. transport channel 24), thereby filling transport blocks (e.g. transport blocks 26).

Communicatively coupled with the TFC selection module 70 is a data buffer 74, in which non-committed user data 80 from logical channels is stored, and transfer queue 78, in which tentatively assigned user data 80 is placed prior to being placed in the transfer channels 82. Each of these memory areas can be logically or physically a single or multiple memory areas. According to one embodiment, logical queues can be formed for pre-processed user data 80 in the buffer 74, as well as for post-processed (or tentatively scheduled) user data 80 in the queue 78 prior to commitment in one or more transport blocks in the transport channel 82.

The TFC selection module 70 is typically stored in non-volatile memory and executed as part of the network protocol stack when in operation on the user application. A significant advantage of the apparatus and system described herein is that it is fast—operating in less than the 10 millisecond TTI in a run-time environment on the user application.

The structure of the TFC selection module 70 can be viewed as a series of sub-modules.

The primary sub-module is a priority loop module 84, which contains a TFC iteration module 86 and an elimination module 90. The TFC iteration module 86 further includes a transfer channel module 88.

The priority loop module 84 is configured to initialize the TFC selection module 70 operating variables and sequentially focus the user data 80 to be operated on to user data having the highest priority over all of the logical channels.

Within the priority loop module 84, the TFC iteration module 86 operates. The TFC iteration module 86 is configured to iterate through each TFC in the TFC data 64 to identify which TFCs are eliminated (or not), and to initialize a queue 74 and buffer 78, which are used for tentative TFC selection.

The transfer channel module 88 operates within the TFC iteration module 86. The transfer channel module 88 uses the mapping data 62 to assist in its performance. The transfer channel module 88 is a routine in a loop over the logical channels associated with each priority, wherein the module 88 is configured to associate user data 80 with a current queue 74 and buffer 78 and make adjustments to the queue 74 and buffer 78 to indicate the tentative TFC selection. Based on the associations made by the transfer channel module, the user data can be broken up into smaller blocks for transmission over subsequent TFCs.

The elimination module 90 is a loop over all TFCs, wherein non-eliminated TFCs are removed as candidates (their state is set to “eliminated”) based on whether the transport occupancy for the current TFC is less than the maximum possible transport occupancy.

Where more than one non-eliminated TFC remains after the elimination module 90 has executed, a separate algorithm can select the TFC using the lowest bit rate as the TFC under which the transport channels 82 should format and transmit the user data 80.

### Hardware Operating Environment

FIG. 4 is a schematic depicting a hardware operating environment in which the inventive structures and techniques can be found and operated. The environment depicted is an exemplary user application 100, such as a 3G wireless communication device.

Microprocessor 104 performs most of the computation and execution of computer readable instructions and software/program modules. Communicatively coupled to the microprocessor 104 are a non-volatile memory 108 (e.g., EEPROM, or flash memory) and a volatile memory 112 (e.g., RAM, DRAM, or SRAM). Computer readable instructions (e.g. executable object code) are typically stored in the non-volatile memory 108 and can be executed from such memory or a faster data rate execution memory area external or internal to the microprocessor 104 at run-time. These instructions should include instructions corresponding to the TFC selection module 70. Thus, the techniques can be embodied in a stripped-down program module that can plug into existing processing environments.

In a like manner, the TFC selection module 70 can be embodied as downloadable computer program code that can be stored in volatile memory 112 or non-volatile memory 108. Further still, the techniques can be embodied in a hard-wired device, such as a gate array or an equivalent electronic device.

However, as is shown in FIG. 4, it is more likely that the hardware environment will include a run-time module 122, a data processing module 120, and a network module 124. The TFC selection module 70 would be included as part of the network protocol stack that is embodied in the network module 124. The run-time module 122 handles the general operating environment of the user application 100, like an operating system would for a standard computer. The run-time module 122 can include sub-modules that drive various elements of the user application 100 such as a keypad, volume controls, a display, etc. The data processing module 120 can include an application program, which is executed over the operating system, or various coders (“coders/decoders”) for processes such as data compression and de-compression, security, and data presentation. The network module 124, which is mentioned above, typically includes the network protocol stack that is responsible for handling, for instance, the UMTS networking protocols.

A transceiver 114, a display 116, and a sound device 118 are also shown communicatively coupled to the microprocessor 104.

The transceiver 114 is configured to handle the physical data link between the user application 100 and the wireless network and can also be configured to handle basic coding and decoding to and from the wireless network. According to one embodiment, the transceiver 114 can be an embedded system that plugs into the device 100, and can further include the network module 124—and even its own microprocessor. In such an embodiment, it is also possible that many, if not all of the networking functions (including TFC selection), are handled by the embedded transceiver 114. (Such an embodiment is intended to be within the scope of the claims below, as are the cases where the techniques are implemented in computer source code or executable object code that is sold as a physical memory, such as in a semiconductor chip, or sold on a tangible medium such as a floppy disk or CD-ROM, or downloaded through a terrestrial or wireless network in one or more packets.)

The display device 116 is configured to present visual data to the user and can be physically embodied in a passive or active matrix liquid crystal display. The sound device 118 is configured to playback and receive sound and can be of any number of commercially available embodiments.

### Protocol Stack

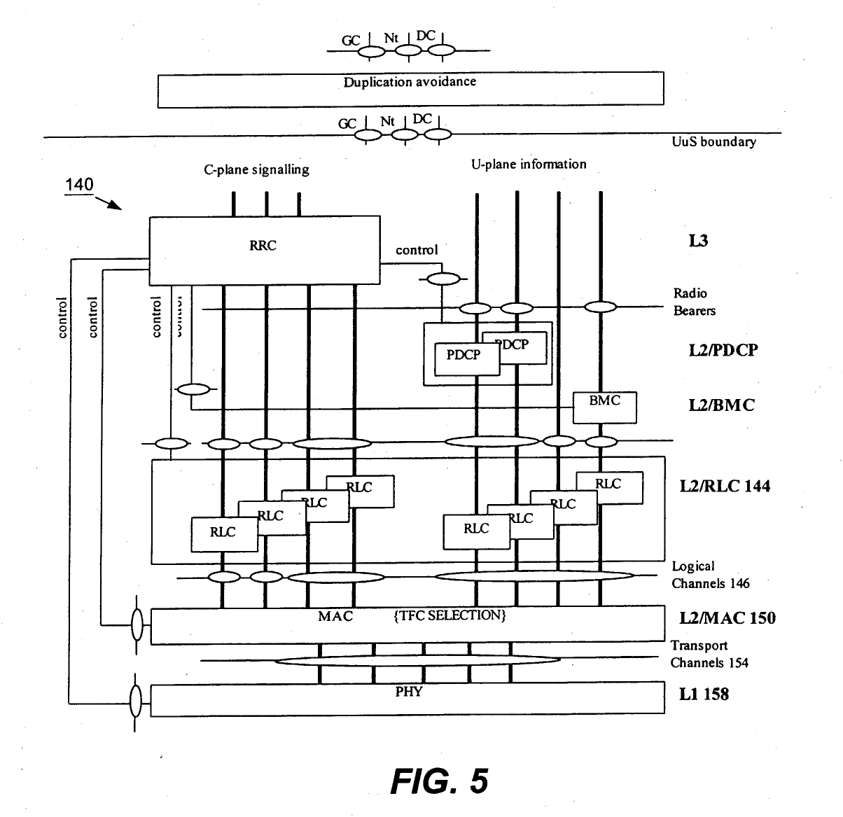

FIG. 5 depicts the UMTS protocol stack 140 showing at which layer in the stack the TFC selection module 70 typically operates. Because the overall UMTS protocol stack 140 is known in the art, it is not explained in detail here. Briefly, however, it is noted that the TFC selection module 70 executes within the MAC sub-layer 150. Again, the MAC sub-layer 150 is the access sub-layer of Layer 2 in the stack 140.

One of the inputs to the TFC selection module is the current buffer occupancy (e.g. buffer 74) on the logical channels 146 at the RLC layer 144. The TFC selection module selects a valid TFC from a set of TFCs available at the current cycle (e.g. the current call). Based on the selected TFC, the number of transport blocks that should be transmitted on each transport channel 154 for that particular transmit time interval (TTI) is determined.

Since there is knowledge of the logical channel 146 to transport channel 154 mapping (e.g. mapping data 62), the system is able to map the logical channels 146 to the transport channels 154 using the methods and techniques described herein. Once a final mapping is made (i.e., a tentative valid TFC is selected), the appropriate user data blocks from each logical channel 146 are allocated into the transport channels 154, after which the physical layer 158 will transmit the user data blocks using the identified transport channels 154. (An exemplary mapping is depicted in FIG. 8 and described in detail below.)

It is further noted that the heavy vertical lines in FIG. 5 correspond to channels. Each future implementation of the UMTS protocol stack may add additional channels to the prior version. As the number of channels increases, so too does the complexity of the TFC selection problems. However, using the methods and techniques described herein, the solutions described are highly scalable. Additional logical channels (beyond the currently envisioned 64 channels) are anticipated by the solutions.

### Variable and Data Definitions

Because of the number of variables involved in the TFC selection algorithm, before presenting a highly detailed description of the TFC selection algorithm, it is helpful to first present these variables and data definitions.

It is noted that different variables are assigned particular letters or symbols, and that pseudo-code presented herein specifies particular data structures and ordering. It should be apparent, however, to one of skill in the art that different letters or symbols can be used for the representation of variables, different data structure ordering, and different loop structures could be employed that still capture the technical considerations, novelty, and inventive step described herein. It is not intended, then, that the claims should be so limited unless such limitations are expressly stated therein.

First, the logical channel is represented by the variable Lᵢ, where 1≦i≦I≦64. The variable Lᵢ has two primary parameters, pᵢ, where 1≦pᵢ≦8, which is the logical channel priority, and dᵢ, which is the type of the channel. (A logical channel priority of 1 is a higher priority than a logical channel priority of 8.) There are three types of channels. A channel type of 1 is an acknowledged mode channel. In this mode tᵢ represents the elementary block size and nᵢ is the number of blocks. A channel type of 2 is a transparent mode channel. In this mode wᵢ represents of the size of the data to transmit. And a channel type of 3 is an unacknowledged mode channel. In this mode, J is the number of service data units (“SDUs”) to transmit, and uᵢⱼ is the size of the SDUj.

The next set of variables that is referenced concerns the transport format combinations (“TFC”s), which are represented by the data structure Tₖ, where 1≦k≦K≦1024. N is the number of transport channels, N≦32, while l is the transport channel number, 1≦l≦N.

Tₖ (also called “the current transport format combination k”) comprises the following variables: m_{k,l}, which is the total number of blocks in the transport channel l; a_{k,l}, which is the number of blocks in the transport channel l that are not used (for the current transport format combination) (also called the “available space”); qₖ, which is the total size of the blocks (having the same priority) transmitted by the current transport format combination k (also called the “transport occupancy”); pₖ is the state of the current transport format combination k—if pₖ is 0, then the current transport format combination k is eliminated, if pₖ is 1, then the current transport format combination k is not eliminated; and vₖ is the total size of the current transport format combination k.

Additional variables include sₗ, which is the block size of transport channel 1, and TTIₗ, which is the transmit time interval of the transport channel l. A multiplier factor, z, is referenced in one embodiment (below), and relates to the TTI of one or more transfer channels. The value for this variable can be calculated after the TFC sets are received, or at least the TTIs for the available transport channels. Another variable, Mᵢ, is shown below, which is the mapping between the logical channel and the transport channel.

Exemplary pseudo-code for data structures representing the logical channels and the transport format combinations are shown in TABLE 2. While a multi-dimensional structure is shown for the TFC, the structure could be embodied in multiple individual structures.

TABLE 2

```
type def {
    char priority;
    char type;
} L[LOGICAL CHANNELS];
type def {
    short int m[TRANSPORT_CHANNELS];
    short int a[TRANSPORT_CHANNELS];
    short int q;
    bool rho;
    short int v;
} T[TFC_COMBINATIONS];
```

Finally, P is the number of existing priorities, fₚ is the first index of the logical channel with priority p, and hₚ is the last index of the logical channel with priority p.

### TFC Selection Algorithm

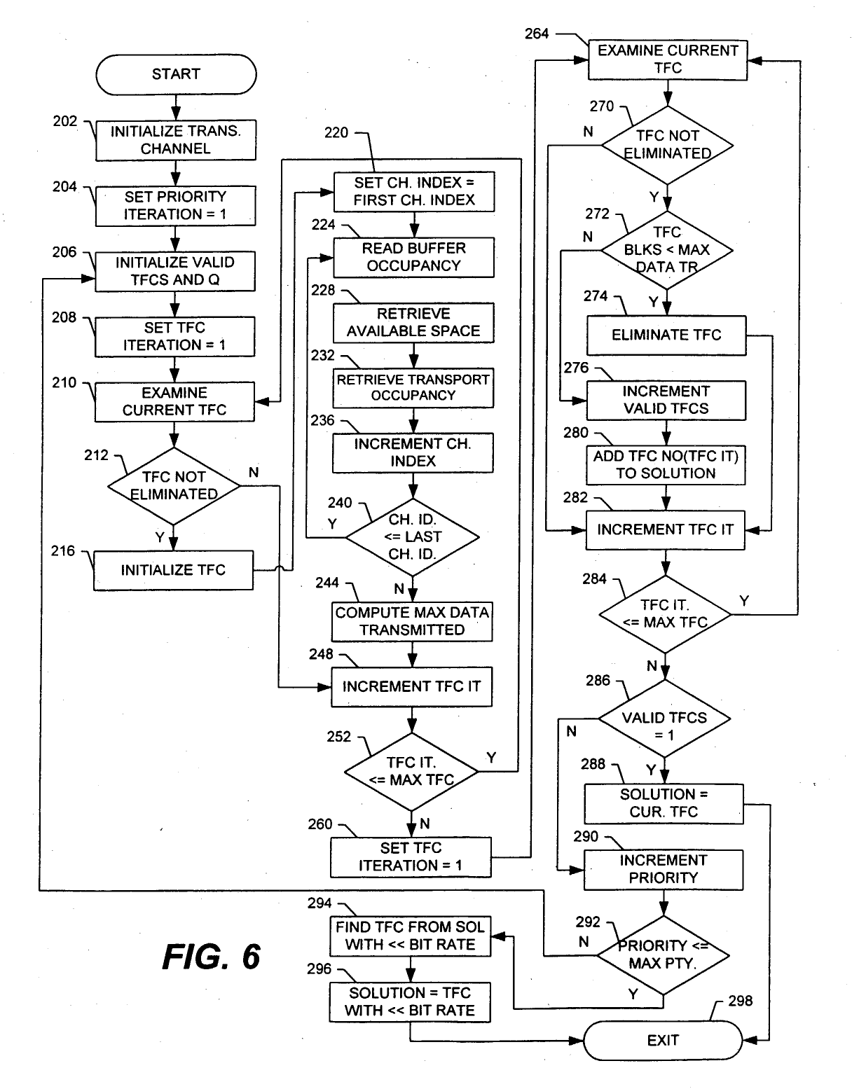

The TFC selection module executes a TFC selection algorithm. This algorithm is typically embodied in a sequence of computer readable instructions (e.g. object code) that are performed during each slot interval by a microprocessor from a memory area. A flowchart depicting and embodiment of the TFC selection algorithm 200 is shown in FIG. 6.

There are three primary loops shown in the TFC selection algorithm 200. The outer-most loop (e.g. 84) is over the logical channel priority (begins with act 202). The first inner loop (e.g. 86) is over the transport format combination iteration (begins with act 208), and a sub-loop (e.g. 88), within the first inner loop, is over the logical channel index numbers that are present in each transport format combination (begins with act 220).

Additional loops are shown too, but most of these are for initialization purposes. One loop, however, is shown, which is a second inner loop (e.g. 90) from the outer-most loop (begins with act 260). This loop iterates over each transport format combination to eliminate undesirable TFCs from the set of candidate TFCs into which the user data from the logical channels could be assigned.

Turning to FIG. 6, the algorithm begins with act 202, which initializes operating parameters, for instance, each transport channel for each transport format combination. This is performed by setting the available buffer capacity (a_{k,l}) equal to the total number of blocks in the transport channel (m_{k,l}). Exemplary pseudo-code for an embodiment of act 202 is shown in TABLE 4 (below).

In act 204, the priority iteration is set to one (one representing the highest priority value).

In act 206, a variable for the number of valid TFCs is set to zero, as is a variable for the maximum data transmitted.

In act 208, the TFC iteration is set to one. In act 210, the TFC (identified by the TFC iteration) is retrieved and examined, for example from the TFC data area 64. In act 212, a test is performed to determine whether the TFC state is “not eliminated” or “eliminated”. If the TFC state is “eliminated”, then processing continues to act 248, otherwise, it continues to act 216. In act 216 a buffer is initialized for the TFC (for example by setting its transport occupancy to zero).

Act 220 begins the sub-loop (e.g. 88). The sub-loop 88, again, tentatively assigns user data from a logical channel to a transport channel—thereby decreasing the available space and increasing the transport occupancy for the transport channel. In act 220, the channel index is set to the first channel index for the current priority. Next, in act 224, the buffer occupancy of the logical channel is read. In act 228, the available space in the transport channel is retrieved, and in act 232, the transport occupancy of the transport channel is retrieved. (The “buffer occupancy” is the amount of user data from a logical channel that needs to be assigned to a transport channel. The “available space” is the amount of space remaining unassigned (i.e. no user data) in the transport channel. And the “transport occupancy” is the amount of space tentatively committed or assigned to user data).

It is noted that the sub-loop is performed based on the type of the logical channel being assigned. As is mentioned above, the types of logical channels include an acknowledged mode, a transparent mode, and an unacknowledged mode. Further details of the sub-loop are described below in the sections entitled “TRANSFER CHANNEL ROUTINE” and “TRANSFER CHANNEL VARIANT ROUTINE” and shown in the pseudo-code.

In act 236, the logical channel index is incremented. In act 240, the logical channel index is compared against the last logical channel index for the current priority. If the logical channel index is less than or equal to the last logical channel index, then processing returns to act 220 (for the next channel index). Otherwise, the sub-loop is complete and processing returns to the first inner loop (to act 244).

In act 244, the maximum data to be transmitted by any non-eliminated TFC for the current priority is computed. It is noted that this value can be increased by subsequent execution of the first loop within the same priority iteration.

In act 248, which can follow acts 244 or 212, the TFC iteration is incremented, and in act 252 the TFC iteration is compared against the number of TFCs to determine whether it is less than or equal to the number of TFCs. If the TFC iteration is less than or equal to the number of TFCs, then processing continues to act 210, which ends the sub-loop and returns to the first inner loop. Otherwise, the first inner loop is exited and processing moves the second loop, which beings in act 260.

In act 268, the second loop is begun by setting the TFC iteration to one. In act 264 the current TFC is retrieved and examined. In act 270, a test is performed on the current TFC to determine whether it is eliminated. If the current TFC is not eliminated, the processing continued to act 272, otherwise, processing continues to act 282.

In act 272, the transport occupancy (i.e., how much data is available for the current TFC assignment) is compared to the maximum data transmitted (calculated from act 256, or Q in the pseudo-code below). (This is a basis for comparing non-eliminated TFCs.) If the transport occupancy is less than or equal to the maximum data transmitted, then the TFC identified by the current TFC iteration number is eliminated in act 274. Otherwise, in act 276, the number of valid TFCs is incremented, and in act 280 the TFC number (i.e., the current TFC iteration) is added to the candidate TFCs in the solution set. This can be performed, for example, by setting a status flag in the TFC data area 64; however, in another embodiment, a list can be built to contain only the non-eliminated TFCs.

After acts 274 or 280, the TFC iteration is incremented in act 282. In act 284, the TFC iteration is tested to determine whether it is less than or equal to the maximum number of TFCs. If the TFC iteration is less than or equal to the maximum number of TFCs, then processing returns to act 264 and the second loop repeats. Otherwise, processing continues to act 286.

In act 286, the number of valid TFCs is tested to determine whether it is equal to one. If the number of valid TFCs is equal to one, then the solution set is the current TFC. Otherwise, in act 290 (the number of valid TFCs is greater than one) the priority iteration is incremented, and in act 292, the priority iteration is compared against the maximum priority value. If the priority iteration is less than the maximum priority value, then processing returns to act 206, which is described above. Otherwise, processing continues to act 294 where the solution set of TFCs is sorted or searched for the TFC with the lowest bit rate.

Any standard sorting or minimizing algorithm can be used to find the TFC from the solution set with the lowest bit rate. In act 296, the resulting TFC is set as the solution. After acts 288 or 296, in act 298 the solution (a single TFC) is returned as the TFC having the transport channels into which the corresponding user data blocks from the logical channels should be assigned or placed.

Pseudo-code representing an embodiment of an algorithm for finding the TFC from the solution set with the lowest bit rate is set forth below in TABLE 3. Pseudo-code representing an embodiment of the TFC selection algorithm is set forth below in TABLE 5. Note that some of the inputs are shown as computed inputs using standard functions, such as the C language int() function.

TABLE 3

```
V [symbol] 0
for k = 1; k ≦ K
    if ρₖ = 1
        if V = 0 or νₖ < V
            Sol [symbol] k
            V [symbol] νₖ
        endif
    endif
endfor
```

TABLE 4 is an embodiment of a parameter initialization routine (act 202 in FIG. 6). TABLE 4 should be inserted above the line marked TABLE 4 in the pseudo-code shown in TABLE 5.

TABLE 4

```
for k = 1; k ≦ K
    for l = 1; l ≦ N
        a_{k,l} [symbol] m_{k,l}
    endfor
endfor
```

TABLE 5

```
for p = 1 ; p ≦ P // insert TABLE 4
  validTFCs [symbol] 0
  Q [symbol] 0
  for k = 1; k ≦ K
    if ρₖ = 1
      qₖ [symbol] 0
      for i = fₚ ; i ≦ hₚ
        l [symbol] Mᵢ
        if dᵢ = 1
          TransferChannel(l, a_{k,l}, tᵢ, nᵢ, qₖ)
        elseif dᵢ = 2
          TransferChannel(l, a_{k,l}, wᵢ / Int(wᵢ / sₗ), Int(wᵢ / sₗ), qₖ)
        else
          for j = 1; j ≦ J
            TransferChannel(l, a_{k,l}, uᵢⱼ / Int(uᵢⱼ / sₗ), Int(uᵢⱼ / sₗ),
              qₖ)
          endfor
        endif
      endfor
      Q = max(Q, qₖ)
    endif
  endfor
  for k = 1; k ≦ K
    if ρₖ = 1
      if qₖ < Q
        ρₖ [symbol] 0
      else
        ValidTFCs [symbol] ValidTFCs + 1
        Sol [symbol] k
      endif
    endif
  endfor
  if ValidTFCs = 1
    exit
  endif
endfor
```

### Transfer Channel Routine

The transfer channel routine, which is represented by acts 220 through 240 in FIG. 6, is described in more detail here.

The transfer channel routine begins by examination of the transport channel that was passed as an input to the transfer channel routine. If the transport channel, l, is scheduled in the current slot, then the algorithm continues, otherwise it ends.

Next, if the block size of the transport channel is equal to the elementary block size of the logical channel, i, and the number of blocks in the transport channel that are not used is greater than zero, then the algorithm continues, otherwise it returns.

If block size of the transport channel is equal to the elementary block size of the logical channel, and the number of blocks in the transport channel that are not used is greater than zero, then the routine finds the minimum of (1) the number of non-used blocks in the transport channel (the available space), and (2) the number of blocks in the logical channel (that is, the buffer occupancy of the user data). This value, d, is used to modify the available space and transport occupancy.

To modify the available space and transport occupancy, the routine first decreases the number of blocks of the transport channel that are not used by the value d. Next, the routine increases the total size of the blocks (having the same priority) that are transmitted by the transport format combination.

There is a chance that two sets of user data blocks with the same priority will arrive for transmission on the same transport channel at the same time. According to one embodiment, to handle such instances, a buffer or queue can be established to temporarily store incoming data blocks in the order they are received so that the user data blocks can be placed into transport blocks in a first in, first out (“FIFO”) manner. In another embodiment, a round-robin approach can be implemented to allocate equivalent transport block space to the dueling user data blocks. (It is noted that this would not impact the selection of the TFC, but only the choice of the user data to be transmitted once a final TFC selection is made.)

Pseudo-code detailing an embodiment of the transfer channel routine is shown in TABLE 6.

TABLE 6

```
TransferChannel (l, a_{k,l}, tᵢ, nᵢ, qₖ)
begin
    if l is scheduled in the current slot
        if( sₗ = tᵢ and a_{k,l} > 0)
            d = min (a_{k,l} , nᵢ)
            a_{k,l} [symbol] a_{k,l} − d
            qₖ [symbol] qₖ + d * tᵢ
        endif
    endif
end
```

### Transport Channel Variant Routine

The transmit time interval, or TTI, for a slot can vary in length. For instance, the slot can be 10, 20, 40 or 80 milliseconds long. UMTS allows for different sizes of TTI and permits the multiplexing of transport channels that do not have the same TTI. Furthermore, when the user data flow arrives in bursts (i.e., large clusters of user data separated by vast periods of null activity—e.g. large files a few times a day), rather than regular user data flows, the baseline transfer channel routine set forth above could be less than optimal in certain scenarios.

Due to constraints on the total signal that can be transmitted in a given time, the number of combinations of multiplexed TTIs are limited. For instance, during a 10 millisecond TTI, the transmitted signal must accommodate the data for a full TTI of the 10 millisecond TTI transport channels appearing in the combination, one half of the 20 millisecond TTI transport channels appearing in the combination, one quarter of the 40 millisecond TTI transport channels appearing in the combination, and one eighth of the 80 millisecond TTI transport channels appearing in the combination.

Because of these constraints, the selection of TFCs is without limits only at the common boundaries of the TTIs (i.e., at some point where all the TTIs begin again, which is typically at the highest TTI size in all the configured transport channels for the TFCS). In other words, if a TFC has two TTIs, say 10 milliseconds and 20 milliseconds, then at 20 millisecond intervals the TFC selection is totally free among the configured TFC set. But when a TFC is selected at a 20 millisecond boundary, a subsequent execution of the TFC selection algorithm will be limited in the choice of TFCs at the next 10 millisecond boundary since the choice is limited to TFCs that have the same transport format at the 20 millisecond TTI transport channel chosen earlier. (Note that there will always be one TFC that works—the TFC that was selected for the 20 millisecond TTI transport channel.)

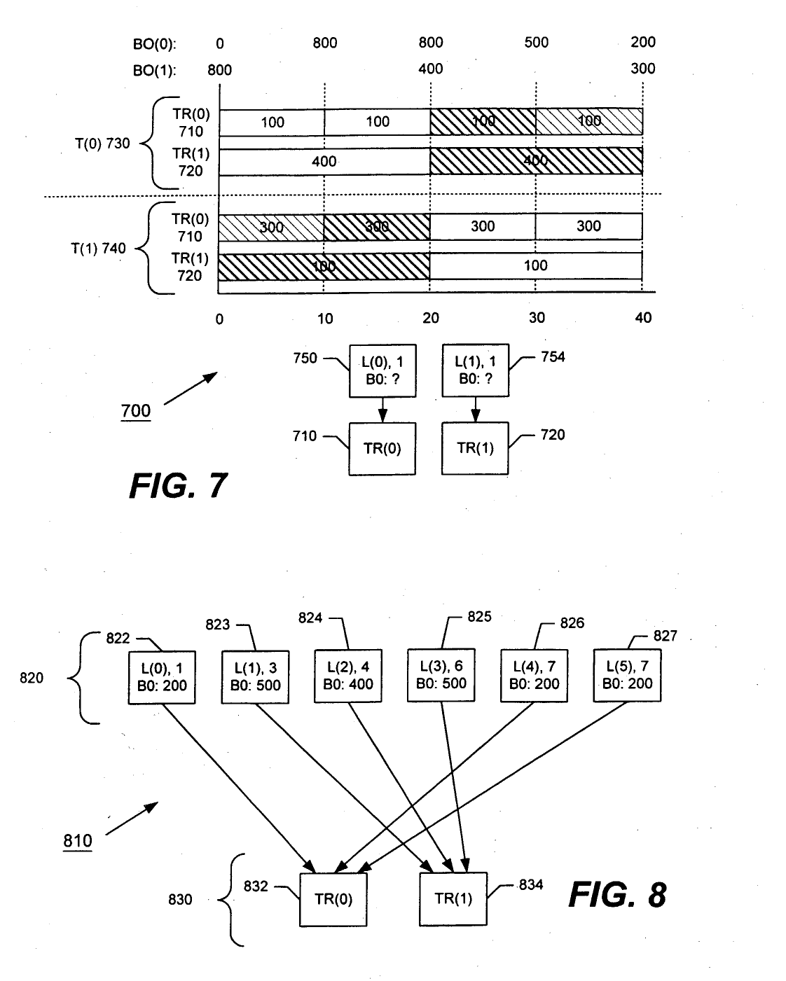

FIG. 7 illustrates the transport channels 710 and 720 for two TFCs 730 (“T(0)”) and 740 (“T(1)”) that are available for an exemplary TFC selection module. Transport channel 710 (“TR(0)”) has a TTI of 10 milliseconds, while transport channel 720 (“TR(1)”) has a TTI of 20 milliseconds. For TFC 730, transport channel 710 can carry a block size of 100 units and transport channel 720 can carry a block size of 400 units. For TFC 740, transport channel 710 can carry a block size of 300 units and transport channel 720 can carry a block size of 100 units.

Logical channel 750 (“L(0)”) maps to transport channel 710, while logical channel 754 (“L(1)”) maps to transport channel 720. Both logical channels 750 and 754 have the same logical channel priority.

If the transport occupancy is calculated for TFCs 730 and 740 as was performed in the prior transport channel routine, and the buffer occupancy for each of the logical channels exceeds the available capacity for each transport channel, then transport occupancy for TFC 730 is 500 and the transport occupancy for TFC 740 is 400 (TABLE 6 shows this formula). This, however, ignores the TTI.

According to the transport channel variant routine, the calculation of the transport occupancy, qₖ, factors in the TTI and multiplies the number of user data blocks to be transmitted by an appropriate multiplier factor. Again, assuming the available space for each of the logical channels exceeds the total capacity for each transport channel, then the transport occupancy for TFC 730 is 600 and the transport occupancy for TFC 740 is 700. The consequence of this is that, in the TFC selection algorithm, the maximum data transmitted, Q, will be a higher value. Thus, the elimination module 90 will have a higher threshold for determining whether a TFC should be flagged as eliminated.

It can be said that the essential difference between the transfer channel routine and the transfer channel variant routine is that act of calculating the transport occupancy further comprises multiplying the size of the user data to be transmitted by the multiplier factor corresponding to the TTI for the current transport channel and TFC. The multiplier factor essentially represents an integer amount by which the current TTI should be multiplied to yield the highest TTI for the TFC.

TABLE 7 is pseudo-code for an exemplary transfer channel variant algorithm.

TABLE 7

```
TransferChannel ( l, a_{k,l}, tᵢ, nᵢ, qₖ )
begin
    if l is scheduled in the current slot
        if ( sₗ = tᵢ and a_{k,l} > 0)
            d = min (a_{k,l}, nᵢ)
            a_{k,l} [symbol] a_{k,l} − d
            qₖ [symbol] qₖ + d * tᵢ * zₗ
        endif
    endif
end
```

Here zₗ is the multiplier factor by which blocks to be transmitted should be multiplied to determine the actual transport occupancy. For example, the multiplier factor would be 1, 2, 4 or 8 in the case of an 80, 40, 20, or 10 millisecond TTI, respectively. Again, the pseudo-code in TABLE 7 is only exemplary; obviously, there can be many ways to determine the multiplier factor for the calculation of the transport occupancy. For instance, since the multiplier value can be calculated once the TFCs are known, the multiplier factors could be pre-established in a look-up table from which the transfer channel variant routine can retrieve a multiplier factor corresponding to the current transport channel, l, and the current TFC, k. In another embodiment, the multiplier factor, z, can be calculated on-the-fly in the transfer channel variant routine.

### Miscellaneous Processing

Pre-processing operations can be performed to setup or initialize certain variables or improve processing prior to or within the execution of the TFC selection algorithm. The functions that follow are used for this purpose and are presented here to show modifications, improvements, and complementary functions for the above-described techniques. Obviously, different algorithms or functions could be employed to determine the values in question.

### Logical Channel to Transport Channel Mapping

Mapping of logical channels to a particular transport channel is handled by the network (e.g. network 52), so it can vary from network to network, and from call to call within the same network.

### Bit Rate Calculation

Bit rates for each transport format combination (“TFC”) are pre-calculated. Again, the TFCs are specified by the network. The bit rates can be calculated using a number of techniques, one technique is shown in pseudo-code in TABLE 8.

TABLE 8

```
for k = 1; k ≦ K
    νₖ = 0
    for l = 1 ; l ≦ N
      1 νₖ [symbol] νₖ + Sₗ. m_{k,l}
    endfor
endfor
```

### EXAMPLES

Two detailed examples of the TFC selection algorithm are presented with reference to accompanying figures and tables. It is useful to first review the FIGS. 7 and 8, and then to study the tables and accompanying text. The first example follows the TFC selection algorithm with the baseline transfer channel routine, but the second example follows the TFC selection algorithm with the transport channel variant routine.

### Example Using Baseline Transfer Channel Routine

FIG. 8 depicts a mapping 810 between a series of logical channels 820 and two transport channels 830.

Logical channel 822 is logical channel “0” (or “L(0)”), and has a priority of 1 and a buffer occupancy of 200. (As a reminder, the buffer occupancy, “BO”, is the amount of user data that needs to be transmitted.) Logical channel 823 is logical channel “1” (or “L(1)”), and has a priority of 3 and a buffer occupancy of 500. Logical channel 824 is logical channel “2” (“L(2)”), and has a priority of 4 and a buffer occupancy of 400. Logical channel 825 is logical channel “3” (“L(3)”), and has a priority of 6 and a buffer occupancy of 500. Logical channel 826 is logical channel “4” (“L(4)”), and has a priority of 7 and a buffer occupancy of 200. Logical channel 827 is logical channel “5” (“L(5)”), and has a priority of 7 and a buffer occupancy of 200. (It is noted that the particular arrangement of the user data above is shown simply for purposes of illustration. The list of priorities and logical channel buffer occupancies, as well as the mappings, could be of any valid arrangement.)

Two transport channels 832 (“TR(0)”) and 834 (“TR(1)”) are shown. Logical channels 822, 826 and 827 map to transport channel 832, while logical channels 823, 824 and 825 map to transport channel 834. The transport channels 832 and 834 will be arranged in different configurations, dictated by the network provision. These configurations, again, are called transport format combinations. TABLE 9 lists 9 TFCs (T(0):T(8)) and their corresponding transport block size by transport channel.

TABLE 9

| TFC | TR(0) size | TR(1) size |
|---|---|---|
| T(0) | 400 | 400 |
| T(1) | 200 | 300 |
| T(2) | 300 | 400 |
| T(3) | 300 | 500 |
| T(4) | 300 | 200 |
| T(5) | 300 | 100 |
| T(6) | 100 | 500 |
| T(7) | 200 | 500 |
| T(8) | 400 | 300 |

In the first iteration, the logical channels with the highest priority are chosen. Here, logical channel 822 (L(0)) has the highest priority. The buffer occupancy of logical channel 822 is 200 and logical channel 822 maps to transport channel 832 (TR(0)), so all the TFCs that can transmit a user block size of 200 are selected as candidate TFCs. From TABLE 9, only TFC combination T(6) does not meet this criteria, so a flag is set indicating that it is an “eliminated” TFC.

The tables that follow show the TFCs remaining after each iteration, and show additional columns to illustrate the portion of the transport channels that are used, the portion of the transport channels that remain, and the amount of data to be transmitted for each MAC layer priority (“MLP”). The example begins with TABLE 10, which shows the state after the first iteration.

TABLE 10

| | TR(0) | TR(1) | TR(0) | TR(1) | TR(0) | TR(1) | | | | | |
|---|---|---|---|---|---|---|---|---|---|---|---|
| TFC | size | size | used | used | rem | rem | MLP1 | MLP3 | MLP4 | MLP6 | MLP7 |
| T(0) | 400 | 400 | 200 | 0 | 200 | 400 | 200 | 0 | 0 | 0 | 0 |
| T(1) | 200 | 300 | 200 | 0 | 0 | 300 | 200 | 0 | 0 | 0 | 0 |
| T(2) | 300 | 400 | 200 | 0 | 100 | 400 | 200 | 0 | 0 | 0 | 0 |
| T(3) | 300 | 500 | 200 | 0 | 100 | 500 | 200 | 0 | 0 | 0 | 0 |
| T(4) | 300 | 200 | 200 | 0 | 100 | 200 | 200 | 0 | 0 | 0 | 0 |
| T(5) | 300 | 100 | 200 | 0 | 100 | 100 | 200 | 0 | 0 | 0 | 0 |
| T(7) | 200 | 500 | 200 | 0 | 0 | 500 | 200 | 0 | 0 | 0 | 0 |
| T(8) | 400 | 300 | 200 | 0 | 200 | 300 | 200 | 0 | 0 | 0 | 0 |

In the second iteration, logical channel 823 (L(1)) has the next highest priority (3). The buffer occupancy of logical channel 823 is 500 and logical channel 823 maps to transport channel 833 (TR(1)), so all the non-eliminated TFCs that can transmit a user block size of 500 are selected as candidate TFCs. From TABLE 10, TFC combinations T(0), T(1), T(2), T(5) and T(8) do not meet this criteria, so a flag is set indicating that they are each eliminated (or invalid) TFCs. TABLE 11 shows the state after the second iteration. (It is noted that here the second iteration is the second iteration where processing is required—the iteration through priority 2 was not counted since there were no logical channels of that priority; this will be the case for priorities 5 and 8 too.)

TABLE 11

| | TR(0) | TR(1) | TR(0) | TR(1) | TR(0) | TR(1) | | | | | |
|---|---|---|---|---|---|---|---|---|---|---|---|
| TFC | size | size | used | used | rem | rem | MLP1 | MLP3 | MLP4 | MLP6 | MLP7 |
| T(3) | 300 | 500 | 200 | 500 | 100 | 0 | 200 | 500 | 0 | 0 | 0 |
| T(7) | 200 | 500 | 200 | 500 | 0 | 0 | 200 | 500 | 0 | 0 | 0 |

In the third iteration, logical channel 824 (L(2)) has the next highest priority (4). The buffer occupancy of logical channel 824 is 400 and logical channel 824 maps to transport channel 833 (TR(1)). Examining TABLE 11, both T(3) and T(7) can transmit a maximum of 0 blocks, so there is no change of state after the third iteration.

In the fourth iteration, logical channel 825 (L(3)) has the next highest priority (6). The buffer occupancy of logical channel 825 is 500 and logical channel 825 maps to transport channel 833 (TR(1)). Examining TABLE 11, both T(3) and T(7) can transmit a maximum of 0 blocks, so there is no change of state after the fourth iteration.

In the fifth iteration, both logical channels 826 (L(4)) and 827 (L(5)) have a priority of 7, so they are handled together. The buffer occupancy for each logical channel is 200 and both map to transport channel 832 (TR(0)). Referring back to TABLE 11, T(3) has one block available for transport channel 832 (TR(0)), but T(7) has no blocks available for transport channel 832. Since T(3) can transmit one more block than T(7), T(7) is eliminated. (It is noted that here is an instance where a FIFO or round-robin technique could be used to select whether logical channel 826 or logical channel 827 were permitted to put its user blocks into the transport channel 832.) The state after the fifth iteration is shown in TABLE 12.

TABLE 12

| | TR(0) | TR(1) | TR(0) | TR(1) | TR(0) | TR(1) | MLP | MLP | MLP | MLP | MLP |
|---|---|---|---|---|---|---|---|---|---|---|---|
| TFC | size | size | used | used | rem | rem | 1 | 3 | 4 | 6 | 7 |
| T(3) | 300 | 500 | 200 | 500 | 0 | 0 | 200 | 500 | 0 | 0 | 100 |

By process of elimination, T(3) is the chosen TFC.

### Example Using Transfer Channel Variant Routine

The TFC selection algorithm with the transfer channel variant is now described with reference to FIG. 7 (described above), and the following tables.

TABLE 13 shows the two TFC arrangements of the transport channels 710 and 720. TR(0) has a TTI of 10 milliseconds, while TR(1) has a TTI of 20 milliseconds. Further, the logical channels are mapped to different transport channels and have the same logical channel priority. (All time units below are milliseconds.)

TABLE 13

| | TR(0) size | TR(1) size |
|---|---|---|
| TFC | (10 ms) | (20 ms) |
| T(0) | 100 | 400 |
| T(1) | 300 | 100 |

At time t=0, the buffer occupancy for the logical channel 750 is 0 and for logical channel 754, the buffer occupancy is 800. Examining the TFC combinations in TABLE 13, it is clear that, using either transport channel routine, T(1) will be selected as the TFC. Thus, the state after t=0 is shown in TABLE 14. (“BO” represents the buffer occupancy remaining for the particular logical channel (X).)

TABLE 14

| | TR(0) | TR(1) | TR(0) | TR(1) | TR(0) | TR(1) | BO(0) | BO(1) |
|---|---|---|---|---|---|---|---|---|
| TFC | size | size | used | used | rem | rem | rem | rem |
| T(0) | 100 | 400 | 0 | 400 | 100 | 0 | 0 | 400 |

At time t=10, assume 800 bytes arrived for logical channel 750. The state would be as shown in TABLE 15.

TABLE 15

| | TR(0) | TR(1) | TR(0) | TR(1) | TR(0) | TR(1) | BO(0) | BO(1) |
|---|---|---|---|---|---|---|---|---|
| TFC | size | size | used | used | rem | rem | rem | rem |
| T(0) | 100 | 400 | 0 | 400 | 100 | 0 | 800 | 400 |

At time t=20, a selection is again made from TABLE 13. Using the transmit channel variant, T(1) is chosen, however, using the standard routing, T(0) would be chosen. The state would be as shown in TABLE 16.

TABLE 16

| | TR(0) | TR(1) | TR(0) | TR(1) | TR(0) | TR(1) | | |
|---|---|---|---|---|---|---|---|---|
| TFC | size | size | used | used | rem | rem | L(0) rem | L(1) rem |
| T(0) | 300 | 100 | 300 | 100 | 0 | 0 | 200 | 300 |

After time t=40, a selection is again made from TABLE 13. Using the transmit channel variant, T(1) is chosen, even though T(0) and T(1) have the same effective transport occupancy, since T(1) has a lower bit rate that T(0). Thus the state would change to what is shown in TABLE 17.

TABLE 17

| | TR(0) | TR(1) | TR(0) | TR(1) | TR(0) | TR(1) | | |
|---|---|---|---|---|---|---|---|---|
| TFC | size | size | used | used | rem | rem | L(0) rem | L(1) rem |
| T(1) | 300 | 100 | 200 | 100 | 0 | 0 | 0 | 200 |

After time t=60, another selection will be made and it should be clear now that T(1) will be selected again, so that there is no more user data blocks to transmit from the logical channels.

TABLE 18 shows a comparison of the two transfer channel routines for another set of user data and the same criteria for the TFCs as shown in TABLE 13. On the left side half of the table is the data for the baseline algorithm, on the right half of the table is the data for the variant algorithm. The user data to transmit is the same for both executions: bursts of data occur at −10 milliseconds (2000 bytes in L(1)) and another at 10 milliseconds (2700 bytes in L(0)), but otherwise there is no activity in the logical channels. One of skill in the art will be able to work through the example given the descriptions provided above.

TABLE 18

| | BO(0) | BO(1) | T(0) | T(1) | Sol | BO(0) | BO(1) | T(0) | T(1) | Sol |
|---|---|---|---|---|---|---|---|---|---|---|
| time | rem | rem | q base | q base | q base | rem | rem | q var | q var | q var |
| −10 | 0 | 2000 | 400 | 100 | | 0 | 2000 | 400 | 100 | |
| 0 | 0 | 1600 | 400 | 100 | T(0) | 0 | 1600 | 400 | 100 | T(0) |
| 10 | 2700 | 1600 | 500 | 400 | T(0) | 2700 | 1600 | 600 | 700 | T(0) |
| 20 | 2500 | 1200 | 500 | 400 | T(0) | 2100 | 1500 | 600 | 700 | T(1) |
| 40 | 2300 | 800 | 500 | 400 | T(0) | 1500 | 1400 | 600 | 700 | T(1) |
| 60 | 2100 | 400 | 500 | 400 | T(0) | 900 | 1300 | 600 | 700 | T(1) |
| 80 | 1500 | 0 | 100 | 300 | T(1) | 300 | 1200 | 600 | 400 | T(0) |
| 100 | 900 | 0 | 100 | 300 | T(1) | 100 | 800 | 500 | 200 | T(0) |
| 120 | 300 | 0 | 100 | 300 | T(1) | 0 | 400 | 400 | 100 | T(0) |
| 140 | 0 | 0 | | | | 0 | 0 | | | |

The apparatus, methods, and structures described above set forth improved techniques for transport format combination selection, and hence user data block assignment for transmission in a network environment. A number of advantages are realized employing these techniques. For instance, the techniques are compact and efficient, more specifically, they are capable of executing in less than the 10 millisecond time interval specified in current implementations of the UMTS protocol. Further, optimized logical channel assignment to transport channels is achieved while still enforcing all of the constraints placed on current UMTS protocol parameters. Further still, the techniques can help achieve a transport format combination selection algorithm that minimizes user application transmission power.

These techniques could be applied in equivalent networks having analogous problems in both terrestrial networks and non-UMTS wireless networks. Finally, except where specified as a limitation in the claims, the specific techniques and pseudo-code detailed above are exemplary and are set forth to assist one of skill in the art in making and using the claimed inventions.

What is claimed is:

1. A user data assignment apparatus for a network, comprising:
a memory region comprising a selection module;
a processing unit communicatively coupled to the memory region, the processing unit configured to execute instructions from the selection module, the instructions including:
a priority loop module configured to sequentially focus user data to be operated on to user data with a particular priority;
a transport format combination iteration module configured to execute within the priority loop module and to iterate through a plurality of transport format combinations; and
a transfer channel module configured to execute within the transport format combination iteration module and to compute transport occupancy information corresponding to assignments of user data to particular transport format combinations.

2. The apparatus of claim 1, further comprising an elimination module configured to execute within the priority loop module and to eliminate assignments of user data to particular transport format combinations based on transport occupancy of the transport format combination relative to a maximum transport occupancy over a plurality of transport format combinations.

3. The apparatus of claim 1, wherein the memory region further comprises:
a mapping data area configured to store information pertaining to a mapping of logical channels to transport channels; and
a transport format combination data area configured to store information pertaining to transport format combinations sent from the network.

4. The apparatus of claim 1, further comprising a user data area configured to store data corresponding to a plurality of priorities and a plurality of types, and of varying sizes, the user data area communicatively coupled to the processing unit.

5. The apparatus of claim 1, wherein the transfer channel module is configured to calculate transport occupancy without regard to transmit time interval data.

6. The apparatus of claim 1, wherein the transfer channel module is configured to calculate transport occupancy with respect to transmit time interval data corresponding to a plurality of transport channels within the transport format combination.

7. The apparatus of claim 1, wherein the network is wireless network.

8. The apparatus of claim 7, wherein the wireless network is a wideband code division multiple access network.

9. The apparatus of claim 7, wherein the processing unit is part of a wireless communication device.

10. The apparatus of claim 7, wherein the processing unit is part of an embedded controller that interfaces with a computing device.

11. A computer implemented method for user data assignment for a network, comprising:
receiving a plurality of user data blocks, the user data blocks having a plurality of priorities;
executing an outer loop over the user data blocks based upon priority;
within the outer loop, executing a transport format combination loop over every non-eliminated transport format combination; and
within the transport format combination loop, executing a transfer channel routine performing acts comprising:
calculating a quantity of user data blocks to transmit;
calculating a transport occupancy based in part on the quantity of user data blocks to transmit; and
assigning the user data blocks to a transport format combination based in part on the transport occupancy information.

12. The method of claim 11, further comprising executing an elimination module within the outer loop, the eliminate module configured to perform acts comprising:
comparing the transport occupancy information to maximum transport occupancy information; and
eliminating the assignment of the user data blocks to the transport format combination when the transport occupancy is less than a maximum transport occupancy over a plurality of transport format combinations.

13. The method of claim 11, further comprising:
accessing a mapping data area for information from the network pertaining to a mapping of logical channels to transport channels; and
accessing a transport format combination data area for information from the network pertaining to transport format combinations.

14. The method of claim 11, further comprising accessing a user data area for information from a user application, the information including a plurality of priorities and a plurality of data types for the user data.

15. The method of claim 11, wherein the transfer channel routine performs the act of calculating the transport occupancy without regard to transmit time interval data.

16. The method of claim 11, wherein the transfer channel routine performs the act of calculating the transport occupancy with respect to transmit time interval data corresponding to a plurality of transport channels within the transport format combination.

17. The method of claim 11, wherein the network is a wireless network.

18. The method of claim 17, wherein the wireless network is a wideband code division multiple access network.

19. The apparatus of claim 17, wherein the computer implemented method is performed in an embedded controller that interfaces with a computing device.

20. A computer readable medium comprising a plurality of signals configured to cause a processor to perform any of the above steps as described in claims 11 through 19.

21. An apparatus for user data assignment for a network comprising:
a priority loop means configured to sequentially iterate over a plurality of user data blocks having a plurality of priorities and corresponding to a plurality of logical channels;
a transport format combination iteration means configured to execute within the priority loop means and to sequentially iterate over a-plurality of transport format combinations corresponding to transport channel configurations that hold user data blocks; and
a transfer channel means configured to execute within the transport format combination iteration means, to access logical channel to transport channel mapping data, and to associate at least portions of user data blocks by logical channel to particular transport channels in a transport format combination.

22. The apparatus of claim 21, further comprising an elimination module means configured to execute within the priority loop means and to eliminate associations made by the transfer channel means based on transport occupancy of the associated transport format combination and a maximum transport occupancy of the plurality of transport format combinations.

23. The apparatus of claim 21, wherein the transfer channel means is configured to calculate transport occupancy without regard to transmit time interval data.

24. The apparatus of claim 21, wherein the transfer channel means is configured to calculate transport occupancy with respect to transmit time interval data corresponding to a plurality of transport channels within the plurality of transport format combinations.

25. A computer implemented method for user data assignment for a network comprising:
executing a priority loop means to sequentially iterate over a plurality of user data blocks having a plurality of priorities and corresponding to a plurality of logical channels;
within the priority loop means, executing a transport format combination iteration means to sequentially iterate over a plurality of transport format combinations corresponding to transport channel configurations that hold user data blocks; and
within the transport format combination iteration means, executing a transfer channel means to access logical channel to transport channel mapping data, and to associate at least portions of user data blocks by logical channel to particular transport channels in a transport format combination.

26. The method of claim 25, further comprising the act of executing, within the priority loop means, an elimination module means to execute within the priority loop means and to eliminate associations made by the transfer channel means based on transport occupancy of the associated transport format combination and a maximum transport occupancy of the plurality of transport format combinations.

27. The apparatus of claim 25, wherein the transfer channel means calculates transport occupancy without regard to transmit time interval data.

28. The apparatus of claim 25, wherein the transfer channel means calculates transport occupancy with respect to transmit time interval data corresponding to a plurality of transport channels within the plurality of transport format combinations.

29. A computer readable medium including therein sequences of signals for user data assignment for a network, the signals configured to cause acts comprising:
executing a priority loop means to sequentially iterate over a plurality of user data blocks having a plurality of priorities and corresponding to a plurality of logical channels;
within the priority loop means, executing a transport format combination iteration means to sequentially iterate over a plurality of transport format combinations corresponding to transport channel configurations that hold user data blocks; and
within the transport format combination iteration means, executing a transfer channel means to access logical channel to transport channel mapping data, and to associate at least portions of user data blocks by logical channel to particular transport channels in a transport format combination.

30. The computer readable medium of claim 29, further comprising signals for causing acts comprising executing, within the priority loop means, an elimination module means to execute within the priority loop means and to eliminate associations made by the transfer channel means based on transport occupancy of the associated transport format combination and a maximum transport occupancy of the plurality of transport format combinations.

31. The computer readable medium of claim 29, further comprising signals for causing the transfer channel means to calculate transport occupancy without regard to transmit time interval data.

32. The computer readable medium of claim 29, further comprising signals for causing the transfer channel means to calculate transport occupancy with respect to transmit time interval data corresponding to a plurality of transport channels within the plurality of transport format combinations.
